(19) United States
(12) Patent Application Publication
(10) Pub. No.: US 2015/0200417 A1
(43) Pub. Date: Jul. 16, 2015

(54) FLEXIBLE SECONDARY BATTERY AND METHOD OF MANUFACTURING THE FLEXIBLE SECONDARY BATTERY

(71) Applicant: Samsung SDI Co., Ltd., Yongin-si (KR)

(72) Inventors: Hyun-Hwa Song, Yongin-si (KR); Feygenson Naum, Yongin-si (KR); Jun-Won Suh, Yongin-si (KR); Jeong-Doo Yi, Yongin-si (KR); Ju-Hee Sohn, Yongin-si (KR); Bong-Kyoung Park, Yongin-si (KR); Hye-Jung Lee, Yongin-si, (KR)

(21) Appl. No.: 14/456,698

(22) Filed: Aug. 11, 2014

(30) Foreign Application Priority Data
Jan. 13, 2014 (KR) 10-2014-0004060

(51) Int. Cl. H01M 10/04; H01M 2/02; H01M 10/0583

(52) U.S. Cl. CPC H01M 10/0431; H01M 10/0583; H01M 2/0202; H01M 2/0217; H01M 2002/0205; H01M 2220/30

(57) ABSTRACT

A flexible secondary battery and a method of manufacturing the flexible secondary battery are disclosed. In one aspect, the flexible secondary battery comprises an electrode assembly including a plurality of curved sections that are continuously formed in a first direction. Each of the sections includes upper and lower portions connected to each other. Each upper portion comprises a left upper portion and a right upper portion spaced apart from each other, wherein the left and upper portions of each section are continuously formed with the adjacent sections. The lower portion of each section is spaced apart from the lower portions of the adjacent sections.

### RELATED APPLICATIONS

This application claims the benefit of Korean Patent Application No. 10-2014-0004060, filed on Jan. 13, 2014, in the Korean Intellectual Property Office, the disclosure of which is incorporated herein in its entirety by reference.

### BACKGROUND

1. Field

The described technology generally relates to flexible secondary batteries.

2. Description of the Related Technology

Due to technological development in electronics, the demand for various portable electronic devices such as mobile phones, game consoles, portable multimedia players (PMP), mpeg audio layer-3 (MP3) players, smartphones, smart pads, electronic book terminals, flexible tablet computers, or mobile medical equipment are remarkably growing.

Devices that are flexible in their use, movement, and storage as well as high durability thereof against impacts are also in increasing demand. Accordingly, the demand for batteries that can provide the flexibility is also increasing.

### SUMMARY OF CERTAIN INVENTIVE ASPECTS

One inventive aspect is a flexible secondary battery for maintaining stability even during repetitive flexing or bending.

Another aspect is a flexible secondary battery that includes: an electrode assembly including a first electrode layer, a second electrode layer, and a separator formed between the first electrode layer and the second electrode layer; and a pouch accommodating the electrode assembly, wherein the electrode assembly includes a plurality of sections that are continuously arranged, and each of the plurality of sections includes a first unit and a second unit, wherein the first unit is arranged next to the second unit in a first direction, wherein the first unit and the second unit each includes a first layer, a second layer on the first layer, and a third layer on the second layer, wherein the first to third layers are continuously formed.

The first layer of the first unit and the first layer of the second unit can be continuously formed to form each of the plurality of sections.

The plurality of sections can include a first section, a second section that is connected to a first side of the first section, and a third section that is connected to a second side of the first section, wherein the third layer of the first unit of the first section is continuously formed with the third layer of the second unit of the second section, wherein the third layer of the second unit of the first section is continuously formed with the third layer of the first unit of the third section.

Each of the first unit and the second unit can include: a first connection portion that is curved by about 180 degrees such that the second layer is disposed on the first layer; and a second connection portion that is curved by about 180 degrees in an opposite direction to a curve direction of the first connection portion such that the third layer is disposed on the second layer.

The electrode assembly can be bent in a direction perpendicular to the first direction, wherein at least one of a gap between the first connection portion of the first unit and the first connection portion of the second unit and a gap between the second connection portion of the first unit and the second connection portion of the second unit is varied.

The first unit and the second unit can be symmetrical with respect to each other with respect to a plane that is perpendicular to the first direction.

At least one of the first unit and the second unit can have an ‘S’ shape.

The pouch can surround an external surface of the electrode assembly and have the same shape as that of the electrode assembly.

The pouch can have a flat external surface and a hollow portion, wherein the electrode assembly is disposed in the hollow portion.

Another aspect is a method of manufacturing a flexible secondary battery, includes: a first forming operation in which a linear electrode assembly is disposed in a first jig and is pressed in a vertical direction for the first time so as to form a plurality of vertical portions and a plurality of first horizontal portions which are connected with one side of the plurality of vertical portions and a plurality of second horizontal portions which are connected with the other side of the plurality of vertical portions; a second forming operation in which the electrode assembly of the first forming operation is disposed in a second jig and pressed for the second time so as to form an inclination in the plurality of vertical portions of the electrode assembly of the first forming operation; and a third forming operation in which the electrode assembly of the second forming operation is disposed in a third jig and is pressed for the third time in the vertical direction.

The electrode assembly of the third forming operation can include a plurality of sections that are continuously arranged, wherein each of the plurality of sections includes a first unit and a second unit is arranged next to the first unit in a first direction, wherein each of the first unit and the second unit includes: a first layer, a second layer, and a third layer that are sequentially stacked; a first connection portion that is curved by about 180 degrees such that the second layer is disposed on the first layer; and a second connection portion that is curved by about 180 degrees in a direction opposite to a curve direction of the first connection portion, such that the third layer is disposed on the second layer.

The first layer of the first unit and the first layer of the second unit can be continuously formed to each of the plurality of sections.

The plurality of sections can include a first section, a second section that is connected to a first side of the first section, and a third section that is connected to a second side of the first section, wherein the third layer of the first unit of the first section is continuously formed with the third layer of the second unit of the second section, and the third layer of the second unit of the first section is continuously formed with the third layer of the first unit of the third section.

The first unit and the second unit can be symmetrical with respect to each other with respect to a surface perpendicular to the first direction.

One of the first unit and the second unit can have an ‘S’ shape.

The method can further include, before the first forming operation, forming a pouch that seals the electrode assembly on an external surface of the linear electrode assembly.

The first horizontal portions can be formed to the first layers of the electrode assembly formed in the third forming operation, the vertical portions can be formed to the second layers of the electrode assembly formed in the third forming operation, and the second horizontal portions can be formed to the third layers of the electrode assembly formed in the third forming operation.

A length of one of the vertical portions can be smaller than a half of a length of one of the first horizontal portions or and a length of one of the second horizontal portions.

Another aspect is a flexible secondary battery, comprising an electrode assembly and a pouch. The electrode assembly includes a first electrode layer, a second electrode layer, and a separator formed between the first and second electrode layers. The pouch accommodates the electrode assembly, wherein the electrode assembly comprises a plurality of sections that are continuously arranged, wherein each of the sections includes first and second units adjacent to each other, wherein each of the first and second units includes a first layer, a second layer continuously extending from the first layer, and a third layer continuously extending from the second layer.

In the above flexible secondary battery, the first layers of the first and second units are continuously formed so as to form each of the sections. In the above flexible secondary battery, the sections comprise a first section, a second section that is connected to a first side of the first section, and a third section that is connected to a second side of the first section, wherein the third layers of the first section are respectively continuously formed with one of the third layers of the second section and one of the third layers of the third section.

In the above flexible secondary battery, each of the first and second units comprises a first connection portion interconnecting the first and second layers, and a second connection portion interconnecting the second and third layers. The above flexible secondary battery further comprises a plurality of first gaps between the first connection portions adjacent to each other, and a plurality of second gaps between the second connection portions adjacent to each other.

In the above flexible secondary battery, the first unit and the second unit are substantially symmetrical to each other with respect to a plane that passes through the middle point of the first layers of the first and second units connected to each other. In the above flexible secondary battery, each of the first and second units has a substantially S or reversed S shape or a substantially zigzag shape.

In the above flexible secondary battery, the pouch substantially surrounds an external surface of the electrode assembly and has substantially the same shape as that of the electrode assembly.

In the above flexible secondary battery, the pouch has a substantially flat external surface and a hollow portion, wherein the electrode assembly is located in the hollow portion.

Another aspect is a method of manufacturing a flexible secondary battery, the method comprising first pressing a substantially linear electrode assembly with a first jig having a plurality of protrusions in a first direction so as to form a plurality of first portions extending in the first direction and a plurality of second portions extending in a second direction crossing the first direction, wherein the first and second portions are alternately formed. The above method further comprises second pressing the first pressed electrode assembly with a substantially linear second jig in the first direction such that each of the first portions and the adjacent second portions form an acute angle, and third pressing the second pressed electrode assembly with a substantially linear third jig in the first direction so as to form a curved electrode assembly.

In the above method, the electrode assembly comprises a plurality of sections that are continuously arranged, wherein each of the sections includes a first unit and a second unit adjacent to each other. In the above method, each of the first unit and the second unit includes first to third layers that are sequentially stacked, a first connection portion interconnecting the first and second layers, and a second connection portion interconnecting the second and third layers. In the above method, the first layer of the first unit and the first layer of the second unit are continuously formed to each of the plurality of sections. In the above method, the sections comprise a first section, a second section that is connected to a first side of the first section, and a third section that is connected to a second side of the first section, wherein the third layers of the first section are respectively continuously formed with one of the third layers of the second section and one of the third layers of the third section.

In the above method, the first and second units are substantially symmetrical to each other with respect to a plane that passes through the middle point of the first layers of the first and second units connected to each other. In the above method, each of the first and second units has a substantially S or reversed S shape or a substantially zigzag shape.

The above method further comprises, before the first pressing, forming a pouch that substantially seals an external surface of the substantially linear electrode assembly.

In the above method, the first portions are connected to the first and third layers, wherein the second portions are connected to the second layers.

In the above method, the length of one of the first portions is smaller than about a half of the length of one of the second portions.

Another aspect is a flexible secondary battery, comprising an electrode assembly including a plurality of curved sections that are continuously formed in a first direction, wherein each of the sections includes upper and lower portions connected to each other, wherein each upper portion comprises a left upper portion and a right upper portion spaced apart from each other, wherein the left and upper portions of each section are continuously formed with the adjacent sections, and wherein the lower portion of each section is spaced apart from the lower portions of the adjacent sections.

In the above method, the lower portion comprises first and second layers each having a top, a bottom and first and second sides, wherein the first sides of the first and second layers are connected to each, other, and wherein a gap is formed between the top of the first layer and the bottom of the second layer. In the above method, each of the sections comprises first and second units substantially symmetrical to each other, wherein each of the first and second units has a substantially S or reversed S shape or a substantially zigzag shape.

### BRIEF DESCRIPTION OF THE DRAWINGS

FIG. 1 is a schematic perspective view illustrating a flexible secondary battery according to an embodiment.

FIG. 2 is a cross-sectional view of the flexible secondary battery cut along a line II-II of FIG. 1 according to an embodiment.

FIG. 3 is a cross-sectional view of the flexible secondary battery cut along a line III-III of FIG. 1 according to an embodiment.

FIG. 4 is a schematic perspective view illustrating a modified example of a flexible secondary battery according to an embodiment.

FIG. 5 illustrates a shape of the flexible secondary battery of FIG. 1 according to an embodiment.

FIGS. 6A through 6C are cross-sectional views illustrating a method of manufacturing the flexible secondary battery of FIG. 1 according to an embodiment.

### DETAILED DESCRIPTION OF CERTAIN INVENTIVE EMBODIMENTS

Reference will now be made in detail to embodiments, examples of which are illustrated in the accompanying drawings, wherein like reference numerals refer to the like elements throughout. In this regard, the present embodiments can have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Because the described technology can have various modifications and several embodiments, exemplary embodiments are shown in the drawings and will be described in detail. Advantages, features, and a method of achieving the same will be specified with reference to the embodiments described below in detail together with the attached drawings. However, the embodiments can have different forms and should not be construed as being limited to the descriptions set forth herein.

The embodiments of the described technology will be described below in more detail with reference to the accompanying drawings. Those components that are the same or are in correspondence are rendered the same reference numeral regardless of the figure number, and redundant explanations are omitted.

It will be understood that although the terms “first”, “second”, etc. can be used herein to describe various components, these components should not be limited by these terms. These components are only used to distinguish one component from another.

Singular expressions, unless defined otherwise in contexts, include plural expressions.

In the embodiments below, it will be further understood that the terms “comprise” and/or “have” used herein specify the presence of stated features or components, but do not preclude the presence or addition of one or more other features or components.

In the embodiments below, It will be understood that when a portion of an element or the like is referred to as being “on” another portion, it can be directly on the other portion or on intervening portions. In this disclosure, the term “substantially” includes the meanings of completely, almost completely or to any significant degree under some applications and in accordance with those skilled in the art. Moreover, “formed on” can also mean “formed over.”

Also, in the drawings, for convenience of description, sizes of elements can be exaggerated or contracted. In other words, since sizes and thicknesses of components in the drawings are arbitrarily illustrated for convenience of explanation, the following embodiments are not limited thereto.

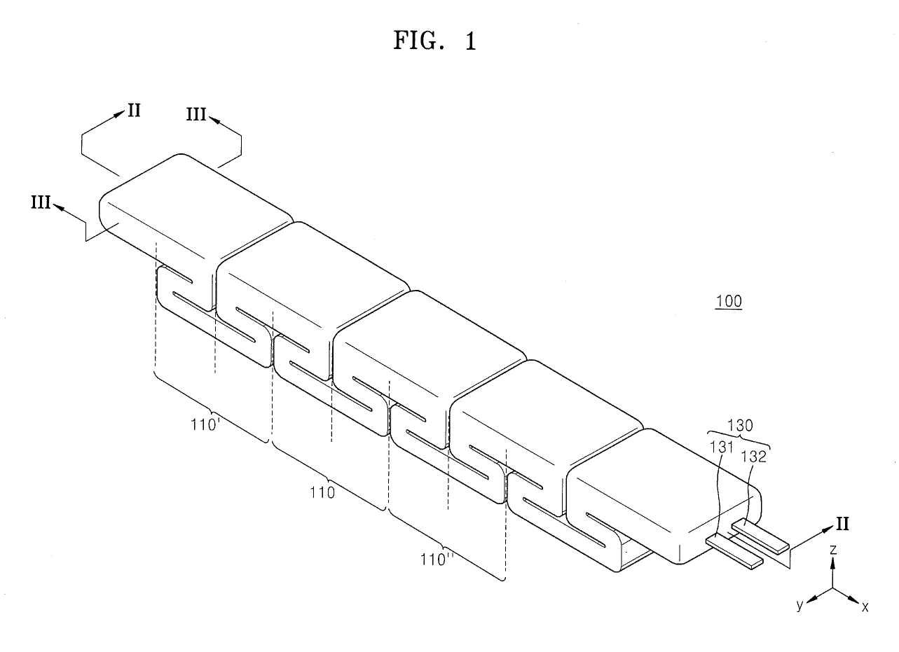

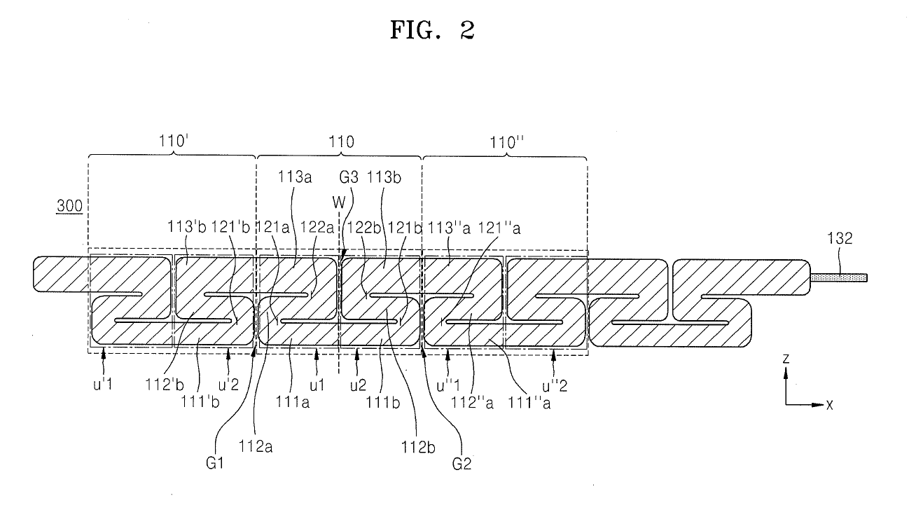

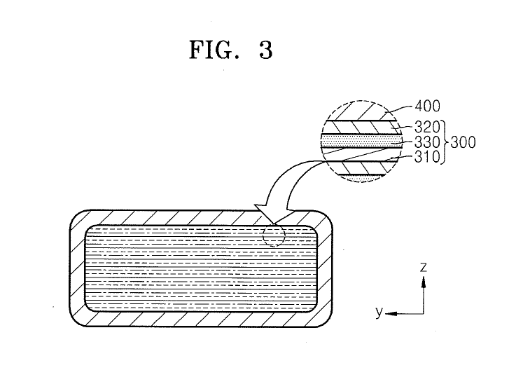

FIG. 1 is a schematic perspective view illustrating a flexible secondary battery 100 according to an embodiment. FIG. 2 is a cross-sectional view of the flexible secondary battery 100 cut along a line II-II of FIG. 1. FIG. 3 is a cross-sectional view of the flexible secondary battery 100 cut along a line III-III of FIG. 1. Referring to FIGS. 1 through 3, the flexible secondary battery 100 can include an electrode assembly 300 and a pouch 400 that accommodates and seals the electrode assembly 300.

Components of the electrode assembly 300 and the structure of the pouch 400 will be described below.

The electrode assembly 300 can include a first electrode layer 310, a second electrode layer 320, and a separator 330 between the first electrode layer 310 and the second electrode layer 320. The electrode assembly 300 can have a stacked structure in which a plurality of first electrode layers 310, a plurality of second electrode layers 320, and a plurality of separators 330 are stacked. In some embodiments, the electrode assembly 300 can have a wound up structure in which the electrode layers 310, the second electrode layers 320, and the separators 330 are wound up. However, for convenience, the description will focus on the stacked structure in which the first electrode layer 310, the second electrode layer 320, and the separator 330 are stacked on one another (see FIG. 3).

The first electrode layer 310 can be a positive or negative electrode film. When the first electrode layer 310 is a positive electrode film, the second electrode layer 320 can be a negative electrode film. When the first electrode layer 310 is a negative electrode film, the second electrode layer 320 can be a positive electrode film.

The first electrode layer 310 can include a first metal collector (not shown) and a first active material portion (not shown) formed of a first active material (not shown) coated on a surface of the first metal collector. Likewise, the second electrode layer 320 can include a second metal collector (not shown) and a second active material portion (not shown) formed of a second active material (not shown) coated on a surface of the second metal collector.

When the first electrode layer 310 is a positive electrode film, the first metal collector can be a positive electrode collector, and the first active material portion can be a positive electrode active material portion. When the second electrode layer 320 is a negative electrode film, the second metal collector can be a negative electrode collector, and the second active material portion can be a negative active material portion.

The positive electrode collector can be formed of a metal such as aluminum, stainless steel, titanium, copper, or silver, or a mixture of these metals. The positive electrode active material portion can be formed of a positive electrode active material and include a binder and a conductive agent.

The positive electrode active material can be a material that is capable of reversibly absorbing or emitting lithium ions. For example, the positive electrode active material can include a lithium transition metal oxide, such as lithium cobalt oxide, lithium nickel oxide, lithium nickel cobalt oxide, lithium nickel cobalt aluminum oxide, lithium nickel cobalt manganese oxide, lithium manganese oxide and lithium ferric phosphate, nickel sulfide, copper sulfide, sulfur, iron oxide, vanadium oxide or a combination thereof.

The binder can be a polyvinylidene fluoride based binder (such as polyvinylidene fluoride, vinylidene fluoride/hexafluoropropylene copolymer, or vinylidene fluoride/tetrafluoroethylene copolymer), a carboxy methylcellulose based binder (such as sodium-carboxy methyl cellulose), an acrylate based binder (such as polyacrylic acid, lithium-polyacrylic acid, acryl, polyacrylonitrile, polymethylmethacrylate, or polybutylacrylate). The binder can also be formed of polyamide-imide, polytetrafluoroethylene, polyethylene oxide, polypyrrole; lithium-nafion, styrene butadiene rubber based polymer or a combination thereof.

The conducting agent can include a carbonic conducting agent formed of carbon black, carbon fibers, and graphite The conducting agent can be formed of a conductive fiber such as metal fibers, metal powder (such as fluorinated carbon powder, aluminum powder, and nickel powder), a conductive whisker (such as zinc oxide and potassium titanium oxide), a conductive metal oxide (such as titanium oxide), and a conductive polymer (such as a polyphenylene derivative).

The negative electrode collector can be formed of copper, stainless steel, nickel, aluminum or titanium. The negative electrode active material portion can be formed of a negative active material and/or include a binder and a conducting agent.

The negative electrode active material can be an allow of lithium or a material that is capable of reversibly absorbing or emitting lithium. For example, the negative electrode active material can include a metal, a carbonic material, a metal oxide, a lithium metal nitride or a combination thereof.

The metal can include lithium, silicon, magnesium, calcium, aluminum, germanium, tin, lead, arsenic, antimony, bismuth, silver, gold, zinc, cadmium, quicksilver, copper, iron, nickel, cobalt, indium, or a combination thereof.

The carbonic material can include graphite, graphite carbon fiber, cokes, mesocarbon microbreads (MCMB), polyacene, pitch based carbon fiber, non-graphitazable carbon (hard carbon), or a combination thereof.

The metal oxide can include a lithium titanate, a titanium oxide, a molybdenum oxide, a niobium oxide, an iron oxide, a tungsten oxide, a tin oxide, an amorphous tin oxide composite, a silicon monoxide, a cobalt oxide, a nickel oxide or a combination thereof.

The binder and the conducting agent of the negative electrode active material portion can be substantially the same as those included in the positive electrode active material portion.

The positive or negative electrode film can be formed by coating a metal collector with an active material portion by using various methods, but the method of coating is not limited.

The separator 330 can be a porous polymer layer such as a polyethylene layer or a polypropylene layer. The separator 330 can be in the form of a woven fabric or a non-woven fiber including polymer fibers that include ceramic particles. The separator 330 can be formed of a polymer solid electrolyte. The separator 330 can be formed of as a non-conductive porous layer formed on the first electrode layer 310 or the second electrode layer 320, or as an independent film.

The separator 330 is included to electrically insulate the first electrode layer 310 from the second electrode layer 320. The shape of the separator 330 does not necessarily have to have the same as the shape of the first electrode layer 310 or the second electrode layer 320.

An electrode tab 130 can be installed to electrically connect the electrode assembly 300 to the outside (e.g., a wall). The electrode tab 130 can include a first electrode tab 131 that is electrically connected to the first electrode 310 and a second electrode tab 132 that is electrically connected to the second electrode layer 320.

The pouch 400 can accommodate an electrolyte, together with the electrode assembly 300, and can seal the electrolyte and the electrode assembly 300. The pouch 400 can have flexible properties, and can prevent penetration of external moisture or oxygen into the flexible secondary battery 100. For example, the pouch 400 can have a three-layer structure including an insulating layer, a metal layer, and an insulating layer. The metal layer can be formed of, for example, steel or stainless steel, and the insulating layer can be formed of, for example, a casted polypropylene (CPP), polyethylene terephthalate (PET) or nylon, but are not limited thereto.

The shape and structure of the electrode assembly 300 will be described below.

Referring to FIG. 2, the electrode assembly 300 includes a plurality of sections 110 that are continuously arranged, and each of the sections 110 includes a first unit u1 and a second unit u2.

In FIG. 2, the first unit u1 is arranged next to the second unit u2 in a length direction of the electrode assembly 300 (hereinafter referred to as a first direction). Also, the first and second units u1 and u2, first layers 111a and 111b, second layers 112a and 112b on the first layers 111a and 111b, and third layers 113a and 113b on the second layers 112a and 112b are continuously formed.

Also, the first and second unit u1 and u2 include first connection portions 121a and 121b that are curved by about 180 degrees such that the second layers 112a and 112b are disposed on the first layers 111a and 111b. The first and second units u1 and u2 also includes second connection portions 122a and 122b that are curved by about 180 degrees in an opposite direction to a curve direction of the second layers 112a and 112b such that the third layers 113a and 113b are disposed on the second layers 112a and 112b. The first and second units u1 and u2 can have a substantially S or reversed S shape or a substantially zigzag shape.

The first layer 111a extends in the reversed X direction and defines the first connection portion 121a that is curved by about 180 degrees such that the second layer 112a is disposed on the first layer 111a. The second layer 112a extends in the X direction and has the second connection portion 122b that is curved by about 180 degrees such that the third layer 113a is disposed on the second layer 112a. The third layer 113a extends in the reversed X direction.

The first layer 111b extends in the X direction and defines the first connection portion 121b that is curved by about 180 degrees such that the second layer 112b is disposed on the first layer 111b. The second layer 112b extends in the reversed X direction and defines the second connection portion 122b that is curved by about 180 degrees such that the third layer 113b is disposed on the second layer 112b. The third layer 113b extends in the X direction.

The first and second units u1 and u2 can be arranged to be substantially symmetrical with respect to each other and with respect to a plane W that is substantially perpendicular to the first direction. The first unit u1 can have an ‘S’ shape, and the second unit u2 can have a shape that is substantially symmetrical to the ‘S’ shape.

The first layers 111a and 111b are connected to form a first section 110. Also, the third layer 113a of the first unit u1 is connected to a third layer 113′b of a second unit u′2 of a second section 110′, and the third layer 113b of the second unit u2 is connected to a third layer 113″a of a first unit u″1 of a third section 110″ that is adjacent to the first section 110. The sections 110, 110′, and 110″ are arranged continuously along the first direction.

Referring to FIG. 3, the pouch 400 is integrally formed with the electrode assembly 300 along an external surface of the electrode assembly 300. Accordingly, the shape of the pouch 400 can be similar to that of the electrode assembly 300.

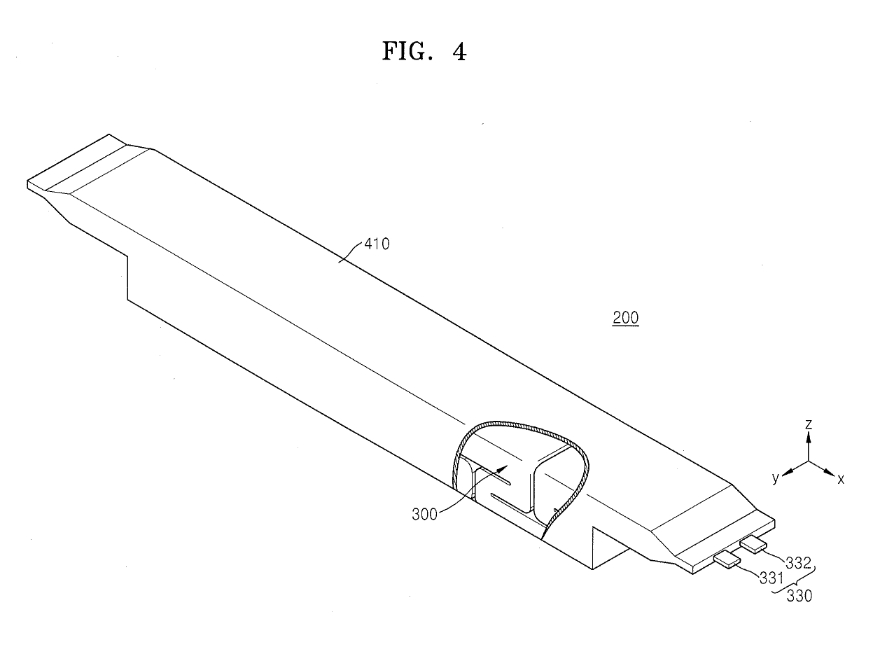

FIG. 4 is a schematic perspective view illustrating a modified example of the flexible secondary battery 200 according to an embodiment. The modified example of the flexible secondary battery 200 according to the current embodiment is different from the flexible secondary battery 100 of the previous embodiment only in terms of the shape of a pouch 410 (as opposed to the pouch 400) and an arrangement of the pouch 410. Thus, details that are common to the previous embodiment are omitted.

Referring to FIG. 4, the pouch 410 can have internal space including a flat external surface and a hollow portion. The electrode assembly 300 can be disposed in the internal space. The electrode assembly 300 is protected from external environments through the pouch 410 and is electrically connected to the outside through an electrode tab 330 including a first electrode tab 331 and a second electrode tab 332.

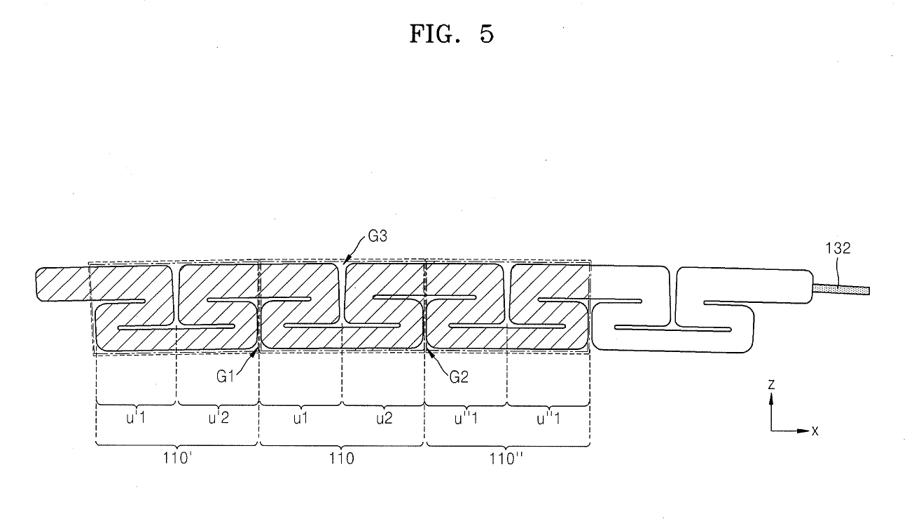

FIG. 5 illustrates a shape of the flexible secondary battery 100 of FIG. 1 according to an embodiment.

Referring to FIG. 5, a bending shape of the flexible secondary battery 100 when an external impact is applied thereto is illustrated.

According to the arrangement of the sections 110, 110′, and 110″ described above, the first connection portion 121a is disposed to face the first connection portion 121′b. Accordingly, a first gap G1 is formed between the first connection portions 121a and 121′b.

Also, the first connection portion 121b is disposed to face the first connection portion 121″a. Accordingly, a second gap G2 is formed between the first connection portions 121b and 121″a.

Also, the second connection portion 122a is disposed to face the second connection portion 122b. Accordingly, a third gap G3 is formed between the second connection portions 122a and 122b. A plurality of gaps are formed between the first unit u1 and the second unit u2 that are arranged continuously by using the arrangement described above.

When an impact force acts on the electrode assembly 300 in a second direction substantially perpendicular to the first direction, the electrode assembly 300 can bend in the second direction. The lengths of the first to third gaps G1 to G3 can vary.

In some embodiments, the impact force acts in the downward direction to the two ends of the electrode assembly 300, the lengths of the first and second gaps G1 and G2 are reduced, and the length of the third gap G3 is increased. When an impact force acts in an upward direction to the two ends of the electrode assembly 300, the widths of the first and second gaps G1 and G2 are increased, and the length of the third gap G3 is reduced.

Typical electrode assemblies are formed linear. When an external force is applied to the typical electrode assembly, stress is concentrated at one point, and when an external force greater than the elastic limit of the typical electrode assembly is applied to the typical electrode assembly, the typical electrode assembly is destroyed where the stress is concentrated (i.e., the one point).

When an external force is applied to the electrode assembly 300, the external force is dispersed throughout the first connection portions 121a and 121b and the second connection portions 122a and 122b. That is, unlike the typical electrode assembly which is linear, the electrode assembly 300 disperses the external force. Accordingly, when substantially the same or greater external force applied to the typical electrode assembly above is applied to the electrode assembly 300, stress is distributed throughout the electrode assembly 300 such that the electrode assembly 300 is not destroyed.

Also, when the electrode assembly 300 receives a force in the second direction, the first to third gaps G1 to G3 can change so as to scatter the external force that the electrode assembly 300 receives. That is, the external force that the electrode assembly 300 receives is scattered as the lengths of the first to third gaps G1 to G3 change, such that the durability of the electrode assembly 300 can be improved accordingly.

Also, as the shape of the electrode assembly 300 or a secondary battery can be diversified according to the shape of an electronic appliance (not shown), internal space utility of the electronic appliance can be increased.

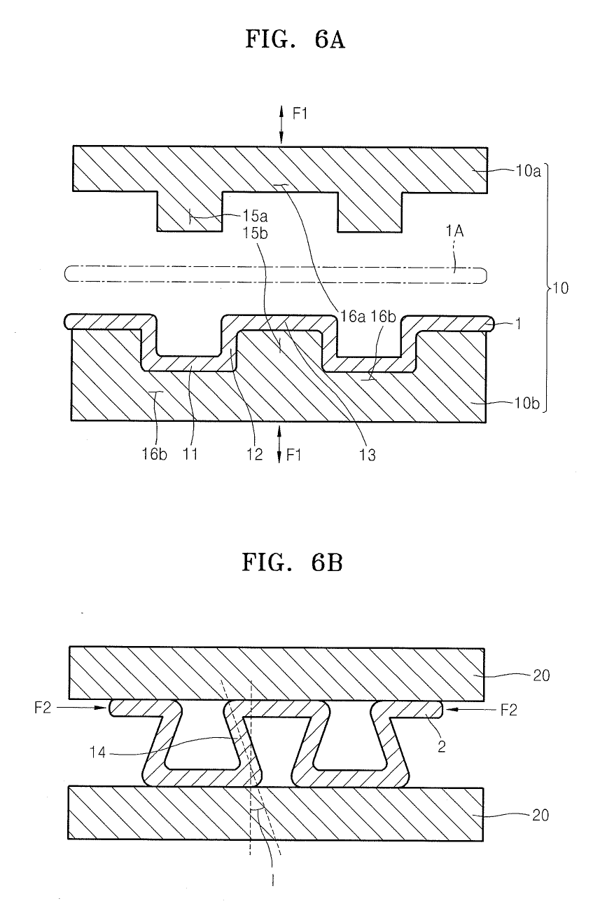

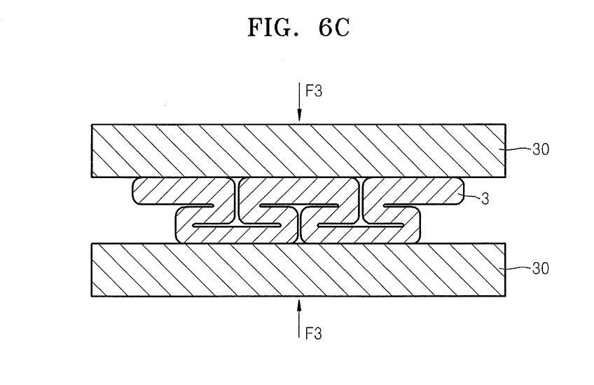

FIGS. 6A through 6C are cross-sectional views illustrating a method of manufacturing the flexible secondary battery 100 of FIG. 1 according to an embodiment. Electrode assemblies 1 to 3 refer to electrode assemblies that are formed of the same material and are distinguished according to manufacturing operations of the flexible secondary battery 200. The electrode assembly 1 and the electrode assembly 300 have the same shape and are formed of the same material, and have only different reference numerals.

The method of manufacturing the flexible secondary battery 100 will be described with reference to FIGS. 6A through 6C. FIG. 6A is a cross-sectional view illustrating a first forming operation S1 of the electrode assembly 1. FIG. 6B is a cross-sectional view illustrating a second forming operation S2 of the electrode assembly 2. FIG. 6C is a cross-sectional view illustrating a third forming operation S3 of the electrode assembly 3.

In the first forming operation S1, the electrode assembly 1 is disposed in a first jig 10, and the first jig 10 is pressed in the vertical direction. The electrode assembly 1 includes a plurality of vertical portions 12, a plurality of first horizontal portions 11 to which first ends of the vertical portions 12 are connected, and a plurality of second horizontal portions 13 to which second ends of the vertical portions 12 are connected. The electrode assembly 1 can be a typical, linear electrode assembly.

The first jig 10 includes a first upper jig 10a and a first lower jig 10b. Each of the first upper jig 10a and the first lower jig 10b includes protrusions 15a and 15b and concave portions 16a and 16b corresponding to the shape of the electrode assembly 1 that is formed in the first forming operation S1. The protrusion 15a of the first upper jig 10a is inserted into the concave portion 16b of the first lower jig 10b, and the concave portion 16a of the first upper jig 10a is inserted into the protrusion 15b of the first lower jig 16b, thereby forming the first electrode assembly 1 in the first forming operation S1. The heights of the vertical portions 12 can be substantially the same. The lengths of the horizontal portions 13 can be substantially the same. The lengths of the horizontal portions 13 can be greater than the heights of the vertical portions 12.

Referring to FIG. 6B, in the second forming operation S2, the first electrode assembly 1 formed by the first forming operation S1 is disposed in a second jig 20. An inclination angle I is formed in the vertical portions 12. In detail, to form the inclination I, the first jig 20 can be fixed in the vertical direction of the electrode assembly 2, and then, a pressure F2 can be applied in the horizontal direction of the electrode assembly 2. Also, the inclination angle I of the vertical portions 12 can be formed by applying a pressure in the vertical and horizontal directions at substantially the same time. A plurality of slated portions 14 can cross the horizontal portions 13. The inclination angle I can be formed at each intersection of the vertical and slanted portions 12 and 14. The amount of pressure F2 can be different from the amount of pressure of F1.

Referring to FIG. 6C, in the third forming operation S3, the electrode assembly 2 formed by the second forming operation S2 is disposed in a third jig 30. The electrode assembly 2 that is formed by the second forming operation S2 is pressed again with a pressure F3 in the vertical direction.

The electrode assembly 3 formed by the third forming operation S3 is substantially identical to the electrode assembly 300 according to the embodiment described above. Thus, details that are common to the previous embodiment are omitted.

Also, before the first forming operation S1, an operation of forming a pouch that seals the electrode assembly 1A can be included. The pouch (not shown) surrounds the external surface of the electrode assembly 1A, and can be formed to have substantially the same shape as that of the electrode assembly 3 as the above forming operations are performed.

The first horizontal portions 11 are formed to be the first layers 111a and 111b, the vertical portions 12 are formed to be the second layers 112a and 112b, and the second horizontal portions 13 are formed to be the third layers 113a and 113b.

In addition, the length of one of the vertical portions 12 can be smaller than about a half of the length of the first horizontal portion 11. Also, the length of one of the vertical portions 12 can be smaller than about a half of the length of the second horizontal portion 13.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the inventive technology have been described with reference to the figures, it will be understood by those of ordinary skill in the art that various changes in form and details can be made therein without departing from the spirit and scope of the present invention as defined by the following claims.

What is claimed is:

1. A flexible secondary battery, comprising:
an electrode assembly, including:
a first electrode layer;
a second electrode layer; and
a separator formed between the first and second electrode layers; and
a pouch accommodating the electrode assembly,
wherein the electrode assembly comprises a plurality of sections that are continuously arranged, wherein each of the sections includes first and second units adjacent to each other,
wherein each of the first and second units includes a first layer, a second layer continuously extending from the first layer, and a third layer continuously extending from the second layer.

2. The flexible secondary battery of claim 1, wherein the first layers of the first and second units are continuously formed so as to form each of the sections.

3. The flexible secondary battery of claim 2, wherein the sections comprise a first section, a second section that is connected to a first side of the first section, and a third section that is connected to a second side of the first section, and
wherein the third layers of the first section are respectively continuously formed with one of the third layers of the second section and one of the third layers of the third section.

4. The flexible secondary battery of claim 1, wherein each of the first and second units comprises:
a first connection portion interconnecting the first and second layers; and
a second connection portion interconnecting the second and third layers.

5. The flexible secondary battery of claim 4, further comprising:
a plurality of first gaps between the first connection portions are adjacent to each other; and
a plurality of second gaps between the second connection portions are adjacent to each other.

6. The flexible secondary battery of claim 1, wherein the first unit and the second unit are substantially symmetrical to each other with respect to a plane that passes through the middle point of the first layers of the first and second units connected to each other.

7. The flexible secondary battery of claim 6, wherein each of the first and second units has a substantially S or reversed S shape or a substantially zigzag shape.

8. The flexible secondary battery of claim 1, wherein the pouch substantially surrounds an external surface of the electrode assembly and has substantially the same shape as that of the electrode assembly.

9. The flexible secondary battery of claim 1, wherein the pouch has a substantially flat external surface and a hollow portion, and
wherein the electrode assembly is located in the hollow portion.

10. A method of manufacturing a flexible secondary battery, the method comprising:
first pressing a substantially linear electrode assembly with a first jig having a plurality of protrusions in a first direction so as to form a plurality of first portions extending in the first direction and a plurality of second portions extending in a second direction crossing the first direction, wherein the first and second portions are alternately formed;
second pressing the first pressed electrode assembly with a substantially linear second jig in the first direction such that each of the first portions and the adjacent second portions form an acute angle; and
third pressing the second pressed electrode assembly with a substantially linear third jig in the first direction so as to form a curved electrode assembly.

11. The method of claim 10, wherein the electrode assembly comprises a plurality of sections that are continuously arranged,
wherein each of the sections includes a first unit and a second unit adjacent to each other,
wherein each of the first unit and the second unit includes:
first to third layers that are sequentially stacked;
a first connection portion interconnecting the first and second layers; and
a second connection portion interconnecting the second and third layers.

12. The method of claim 11, wherein the first layer of the first unit and the first layer of the second unit are continuously formed to each of the plurality of sections.

13. The method of claim 12, wherein the sections comprise a first section, a second section that is connected to a first side of the first section, and a third section that is connected to a second side of the first section, and
wherein the third layers of the first section are respectively continuously formed with one of the third layers of the second section and one of the third layers of the third section.

14. The method of claim 11, wherein the first and second units are substantially symmetrical to each other with respect to a plane that passes through the middle point of the first layers of the first and second units connected to each other.

15. The method of claim 14, wherein each of the first and second units has a substantially S or reversed S shape or a substantially zigzag shape.

16. The method of claim 11, further comprising, before the first pressing, forming a pouch that substantially seals an external surface of the substantially linear electrode assembly.

17. The method of claim 11, wherein the first portions are connected to the first and third layers, and wherein the second portions are connected to the second layers.

18. The method of claim 10, wherein the length of one of the first portions is smaller than about a half of the length of one of the second portions.

19. A flexible secondary battery, comprising:
an electrode assembly including a plurality of curved sections that are continuously formed in a first direction,
wherein each of the sections includes upper and lower portions connected to each other,
wherein each upper portion comprises a left upper portion and a right upper portion spaced apart from each other,
wherein the left and upper portions of each section are continuously formed with the adjacent sections, and
wherein the lower portion of each section is spaced apart from the lower portions of the adjacent sections.

20. The flexible secondary battery of claim 19, wherein the lower portion comprises first and second layers each having a top, a bottom and first and second sides,
wherein the first sides of the first and second layers are connected to each other, and
wherein a gap is formed between the top of the first layer and the bottom of the second layer.

21. The flexible secondary battery of claim 19, wherein each of the sections comprises first and second units substantially symmetrical to each other, and wherein each of the first and second units has a substantially S or reversed S shape or a substantially zigzag shape.
